(19) United States
(12) Patent Application Publication
(10) Pub. No.: US 2026/0102893 A1
(43) Pub. Date: Apr. 16, 2026

(54) SYSTEMS AND METHODS FOR A HYDRAULIC TOOL

(71) Applicant: Milwaukee Electric Tool Corporation, Brookfield, WI (US)

(72) Inventors: Connor F. Galarneau, Brookfield, WI (US); Alex P. Grotelueschen, Brookfield, WI (US)

(21) Appl. No.: 19/355,657

(22) Filed: Oct. 10, 2025

Related U.S. Application Data
(60) Provisional application No. 63/708,130, filed on Oct. 16, 2024.

(51) Int. Cl. B25F 5/00

(52) U.S. Cl. CPC B25F 5/005

(57) ABSTRACT

A hydraulic power tool includes a trigger, motor, pump, hydraulic circuit, fluid reservoir, pressure sensor, and controller. The controller initiates motor operation when the trigger is depressed, causing the pump to move hydraulic fluid through the circuit. The controller monitors pressure via the sensor, calculates a pressure derivative representing the rate of pressure change over time, and increments a buffer counter when the pressure derivative is at or near zero. When the pressure derivative remains at or near zero for a predetermined time period, indicating work operation completion, the controller automatically releases hydraulic fluid from the circuit back to the reservoir.

### CROSS-REFERENCE TO RELATED APPLICATIONS

This application claims the benefit of U.S. Provisional Application No. 63/708,130, filed on Oct. 16, 2024, which is incorporated by reference herein in its entirety.

### BACKGROUND

Work tools (e.g., cutting tools, crimping tools, etc.) permit operators to perform various operations (e.g., crimping, cutting, etc.) on many different workpieces (e.g., electrical wires, power cables, sheet metal, etc.). For example, some cutting tools can include a cutting head that is driven (e.g., hydraulically, or electrically) into a workpiece (e.g., a cable) to cut through the workpiece.

### SUMMARY

According to one aspect of the present disclosure, a hydraulic power tool can include a trigger, a motor, a pump driven by the motor, a hydraulic circuit in fluid communication with the pump, a fluid reservoir in communication with the hydraulic circuit to store a hydraulic fluid, a pressure sensor in communication with the hydraulic circuit, and a controller in communication with the motor, the pressure sensor, and the trigger. The controller can initiate motor operation in response to depression of the trigger, where the motor operation can cause the pump to move hydraulic fluid from the fluid reservoir through the hydraulic circuit. The controller can monitor a pressure within the hydraulic circuit via pressure measurements from the pressure sensor. The controller can calculate a pressure derivative representing a rate of change of the pressure over time. The controller can increment a buffer counter when the pressure derivative is at or near zero. The controller can detect when the pressure derivative remains at or near zero for a predetermined time period to indicate that a work operation is complete. When the pressure derivative is detected to be at or near zero for the predetermined time period, the controller can automatically release the hydraulic fluid from the hydraulic circuit back to the fluid reservoir.

In some examples, the controller may further determine when the pressure drops below a threshold, where the threshold may be a rate threshold indicative of the rate of change of the pressure measurements over time.

In some examples, the rate threshold may be indicative of a completion of a cut by the hydraulic power tool.

In some examples, the rate threshold may be indicative of a piston of the hydraulic circuit reaching a closed position.

In some examples, the controller may be further configured to monitor the pressure derivative within the hydraulic circuit and determine when the pressure derivative is at or near zero for a predetermined time period before automatically releasing the hydraulic fluid.

In some examples, the predetermined time period may be in a range of about 50 milliseconds to about 250 milliseconds.

In some examples, the controller may be further configured to detect when the pressure within the hydraulic circuit exceeds a first threshold indicating initiation of the work operation and subsequently detect when the pressure drops below a second threshold indicating completion of the work operation.

In some examples, the second threshold may have a pressure value that is lower than the first threshold.

In some examples, the hydraulic power tool may further include at least one of recording and storing a maximum pressure sensed during the work operation, where the work operation may be defined from when the trigger is depressed to when the pressure exceeds the second threshold, or recording and storing a maximum pressure sensed during a work cycle, where the work cycle may be defined from when the trigger is depressed to when the trigger is released.

In some examples, the controller may include a buffer counter that may be incremented when a pressure derivative is at or near zero and decremented when the pressure derivative is not close to zero.

In some examples, the controller may automatically release the hydraulic fluid when the buffer counter reaches a predetermined full state.

According to another aspect of the present disclosure, a method of operating a hydraulic power tool can include initiating motor operation in the hydraulic power tool in response to activation of an actuator of the hydraulic power tool, activating a pump of the hydraulic power tool, via initiation of the motor operation, to move hydraulic fluid from a fluid reservoir through a hydraulic circuit, monitoring a pressure within the hydraulic circuit via a pressure sensor arranged within the hydraulic power tool, calculating a pressure derivative representing a rate of change of the pressure over time, incrementing a buffer counter when the pressure derivative is at or near zero, detecting when the pressure derivative remains at or near zero for a predetermined time period indicating a work operation of the hydraulic tool is completed, and upon detecting that the pressure derivative remains at or near zero for a predetermined time period, releasing the hydraulic fluid from the hydraulic circuit back to the fluid reservoir.

In some examples, the predetermined time period may be in a range of about 50 milliseconds to about 250 milliseconds.

In some examples, the method may further include detecting when the pressure within the hydraulic circuit exceeds a first threshold indicating initiation of the work operation before monitoring the pressure derivative.

In some examples, the method may further include detecting when the pressure within the hydraulic circuit drops below a second threshold indicating preliminary completion of the work operation before calculating the pressure derivative.

In some examples, the method may further include raising status flags in firmware when predetermined pressure conditions are detected during the work operation.

According to yet another aspect of the present disclosure, a method of operating a hydraulic power tool can include initiating motor operation in a hydraulic power tool in response to activation of an actuator, pumping hydraulic fluid from a fluid reservoir through a hydraulic circuit via initiation of the motor operation, monitoring a pressure within the hydraulic circuit, detecting when the pressure varies at a rate that exceeds a first threshold indicating a work operation of the hydraulic tool is completed, and upon detecting that the pressure varies at the rate that exceeds the first threshold indicating the work operation is completed, releasing the hydraulic fluid from the hydraulic circuit back to the fluid reservoir.

In some examples, the first threshold may correspond to a pressure drop rate.

In some examples, the first threshold may correspond to a pressure rise rate.

In some examples, the method may further include raising status flags in firmware upon detecting that the pressure varies at the rate that exceeds the first threshold.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a side view of one example of a hydraulic tool according to aspects of the present disclosure.

FIG. 2 is a cross-sectional view of an example cutting assembly for use with the hydraulic tool of FIG. 1.

FIG. 3 is a diagrammatic view of components of a hydraulic and electronic control system of the hydraulic tool of FIG. 1.

FIG. 4A is a flowchart of an example cut process of the hydraulic tool of FIG. 1.

FIG. 4B is a graph corresponding to the process shown in FIG. 4A.

FIG. 5A is a flowchart of another example cut process of the hydraulic tool of FIG. 1.

FIG. 5B is a graph corresponding to the process shown in FIG. 5A.

FIG. 6A is a flowchart of yet another example cut process of the hydraulic tool of FIG. 1.

FIG. 6B is a graph corresponding to the process shown in FIG. 6A.

FIG. 7A is a flowchart of yet another example cut process of the hydraulic tool of FIG. 1.

FIG. 7B is a graph corresponding to the process shown in FIG. 7A.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In some examples, a hydraulic tool may include an automatic blade retraction mechanism that automatically retracts a blade of the hydraulic tool (e.g., back into a “home” position). For example, the automatic blade retraction mechanism may retract the blade after the hydraulic tool completes a cut (or crimp, or other work operation) to mitigate force or pressure on the tool, which may improve overall reliability of the tool. For example, in use, the hydraulic tool may be configured to monitor a work operation on a workpiece, and the blade retraction mechanism can automatically dump hydraulic fluid from a hydraulic chamber back into a reservoir (e.g., a fluid retention location) once the cut is completed. In some examples, during the work operation, the hydraulic tool may record both a maximum cut pressure (e.g., a maximum pressure needed to cut the workpiece) and a maximum cycle pressure (e.g., a maximum pressure reached during the work operation).

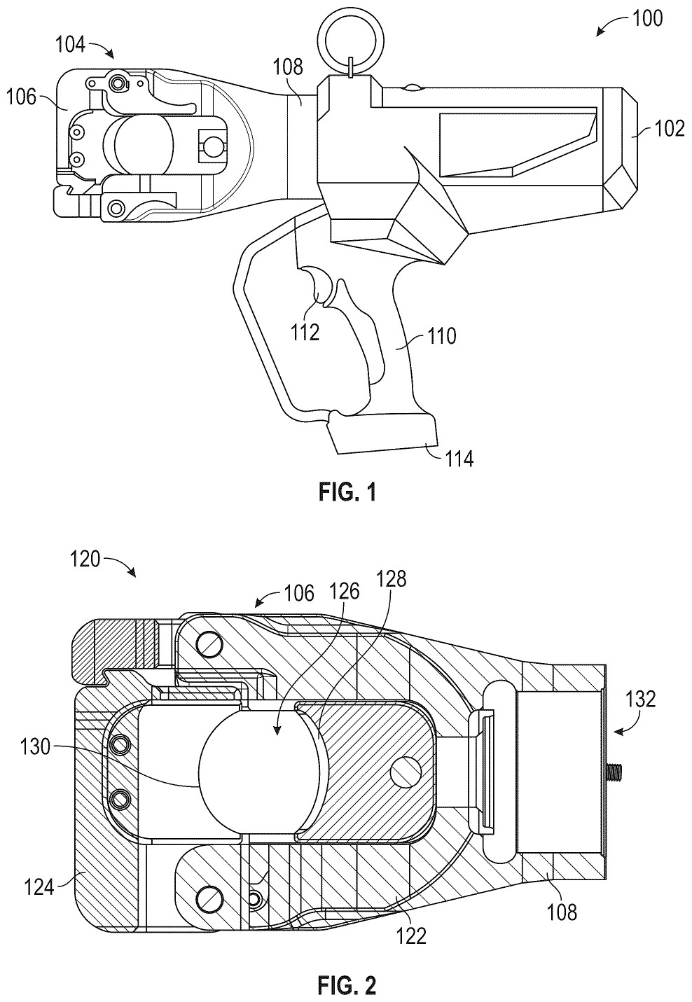

With reference to FIG. 1, a hydraulic tool 100 according to an example of the present disclosure is shown. In one example, the hydraulic tool 100 may be a cutting tool. The hydraulic tool 100 includes a housing 102 that receives a cutter assembly 104 having a head 106 and a body 108. In one example, the body 108 of the assembly 104 may be positioned within the housing 102 of the tool 100 while the head 106 of the assembly 104 is positioned outside of the housing 102. The housing 102 may further include a handle 110 to permit a user to grip and maneuver the tool 100. In one example, the handle 110 extends substantially perpendicular to the head 106. However, in other examples, the handle 110 may extend substantially parallel to the head 106 (e.g., in line with the head 106). In some examples, the user may activate or deactivate operation of the tool 100 via activation of an actuator. In some examples, the actuator may be in the form of a trigger 112 positioned on the handle 110. However, in other examples, tool 100 can be controlled using a remote device or using a mobile application (e.g., on a mobile phone or laptop), although other configurations are possible.

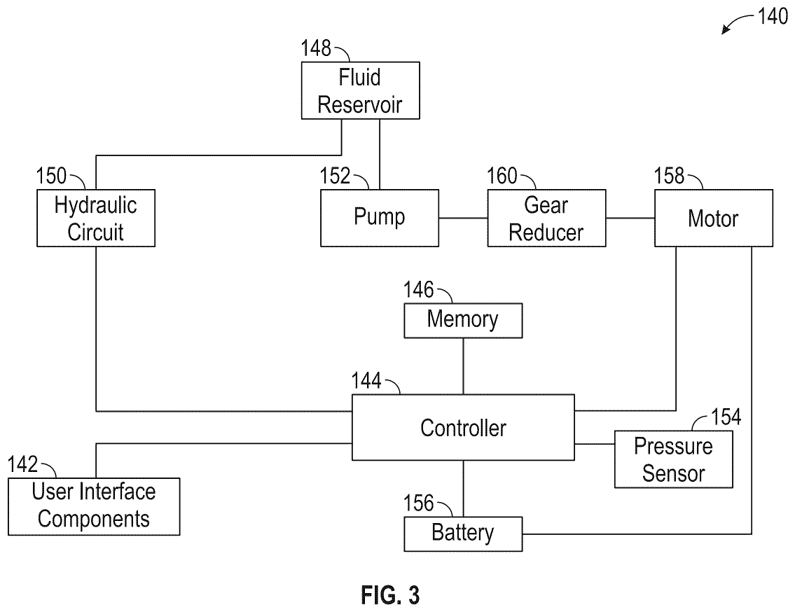

In some examples, to control operation of the tool 100, a user activates the tool 100 by depressing the trigger 112. Correspondingly, the tool 100 may be deactivated by releasing the trigger 112. In one particular example, the tool 100 includes a battery receptacle 114 configured to receive and secure a battery (e.g., a rechargeable lithium ion battery, etc.) to power the tool 100 (such as the battery 156 illustrated in FIG. 3). However, in other examples, the tool 100 may include a power cord to supply power to the tool 100.

In some examples, the head 106 of the assembly 104 generally defines a U-shape, though the head 106 may define other geometries, such as a C-shape, or others. For example, FIG. 2 illustrates another example of a cutter assembly 120, that may be used with the hydraulic tool 100 of FIG. 1.

As shown in FIG. 2, the head 106 of the cutter assembly 120 includes a first frame 122 and a second frame 124. The second frame 124 is moveable relative to the first frame 122 so that the tool head 106 can be opened to insert a workpiece into a cutting zone 126. In some examples, the tool head 106 can be moved into a closed position in order to facilitate cutting the workpiece in the cutting zone 126. The tool head 106 further includes a first blade and a second blade within the respective first and second frames 122, 124. For example, the tool head 106 includes a first blade 128 slidably disposed in the first frame 122 and a second blade 130 coupled to the second frame 124. The first blade 128 is moveable from a proximal end of the cutting zone 126 toward the second blade 130 at a distal end of the cutting zone 126. Accordingly, the first blade 128 and the second blade 130 provide a guillotine-type cutting action. However, in other examples, the first and second blades 128, 130 may be arranged to provide other cutting actions (e.g., shear-type actions, scissor-type actions, etc.).

In some examples, a hydraulic actuator assembly is coupled to a proximal end 132 of the head 106 and is configured to move the first blade 128 toward the second blade 130 to cut an object (e.g., a workpiece) positioned in the cutting zone 126. For example, the actuator assembly includes a pump configured to provide pressurized hydraulic fluid to a hydraulic circuit and a ram configured to move the first blade 128. In some examples, the pump provides pressurized hydraulic fluid, which moves the ram to provide corresponding movement to the first blade 128 across the cutting zone 126, towards the second blade 130.

Turning now to FIG. 3, a hydraulic and electronic control system 140 of the hydraulic tool 100 is shown. The hydraulic and electronic control system 140 may include one or more user interface components 142, a controller 144, a memory 146, a fluid reservoir 148 in fluid communication with a hydraulic circuit 150 and a pump 152, a pressure sensor 154, a battery 156, a motor 158, and a gear reducer 160.

In some examples, the user interface component(s) 142 is configured to provide input to the power tool 100, such as to the controller 144 of the power tool 100. In particular, in this example, the user interface components 142 include the trigger 112 (see, e.g., FIG. 1), an operator panel, one or more switches, one or more push buttons, one or more interactive indicating lights, soft touch screens or panels, other types of similar switches, or any combination thereof.

The controller 144 (which may also be referred to as a motor control unit or a motor inverter) includes a processor and is connected to the memory 146, the user interface component(s) 142, the hydraulic circuit 150, the pump 152, and the pressure sensor 154, and is powered by the battery 156. For example, the hydraulic circuit 150, the pump 152, or the pressure sensor 154 are configured to provide certain operating information and operational data to the controller 144, as further described below. Furthermore, in some examples, the controller 144 can include a printed circuit board assembly (PCBA). In some examples, the memory 146 is a non-transitory computer readable medium and includes a program storage area and a data storage area. In particular, the data storge area includes a plurality of look up table of values. For example, at least one stored look up table may include work piece information or data, such as maximum fluid pressures in the hydraulic circuit 150, as further described below. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The program storage area includes instructions that, when executed by the processor, cause the controller 144 to operate the tool 100.

In some examples, the electric motor 158 is powered by the battery 156 and is controlled by the controller 144. Furthermore, the electric motor 158 is configured to drive the pump 152 by way of the gear reducer 160. In particular, the pump 152 is driven to draw fluid from the fluid reservoir 148 (e.g., generally stored around or at atmospheric pressure), to pressurize the fluid, and deliver the fluid to the hydraulic circuit 150. For example, when a user depresses the trigger 112 to perform a work operation with the tool 100 (e.g., a cutting operation), the pump 152 is driven to provide pressurized hydraulic fluid to the hydraulic circuit 150. The pressurized hydraulic fluid within the hydraulic circuit then drives the ram of a hydraulic actuator cylinder within the hydraulic circuit 150 toward the head 106 to move the first blade 128 from a most proximal position (e.g., a home position, as illustrated in FIG. 2), across the cutting zone 126 toward a most distal position adjacent the second blade 130 (e.g., a closed position).

Additionally, in some examples, during the work operation, a pressure of the hydraulic fluid within the hydraulic circuit 150 is monitored by the controller 144 via the pressure sensor 154. That is, the pressure sensor 154 (e.g., pressure transducer) is in communication with the fluid distribution network, such as located within the hydraulic circuit 150. In particular, the pressure sensor 154 is configured to provide measurements to the controller 144 indicative of a pressure within the hydraulic circuit 150.

Generally, when the work operation is complete, the user releases the trigger 112, which causes the controller 144 to stop the motor 158. When the motor 158 stops, the tool 100 pauses the ram and maintains the hydraulic pressure at its current level. In some examples, to release the high pressure fluid from the hydraulic circuit 150 back to the fluid reservoir 148, the tool 100 can include a second trigger that may be actuated by a user to initiate a hydraulic dump sequence. Alternatively, in other examples, users may continue to drive the motor 158 until deadhead or “bottoming out” occurs which automatically triggers a hydraulic dump sequence but may cause unwanted wear and tear on the tool. In some examples, the hydraulic dump sequence includes opening one or more valves within the hydraulic circuit 150 (e.g., in response to instructions from the controller 144) to permit the pressurized fluid to release back to (e.g., return to) the fluid reservoir 148. As such, the hydraulic dump sequence, in some examples, is configured to be an electronics-based sequence controlled by the controller 144.

In an example operation of the cutter assembly 120 shown in FIG. 2, in which the cutting head 106 includes the first blade 128 and the second blade 130, the head 106 completes a work operation when the first blade 128 and the second blade 130 are in the closed position after the workpiece has been cut. More generally, the closed position may be a position in which blades 128, 130 of the head 106 are at a minimum distance relative to each other. For simplicity, the following discussion will refer to the cutter assembly 120, first blade 128, and second blade 130.

According to some examples, the hydraulic tool 100 is configured to automatically determine when a work operation (e.g., a cutting operation, crimping operation, etc.) is complete and, upon such determination, retract the first blade 128 into the home position. More specifically, upon such determination, the hydraulic tool 100 releases the high pressure fluid from the hydraulic circuit 150 back to the fluid reservoir 148 to permit the first blade 128 to retract back to the home position, as noted above. For example, the controller 144 determines a status of the work operation based on pressure signals from the pressure sensor 154 and controls automatic blade retraction based on these pressure signals.

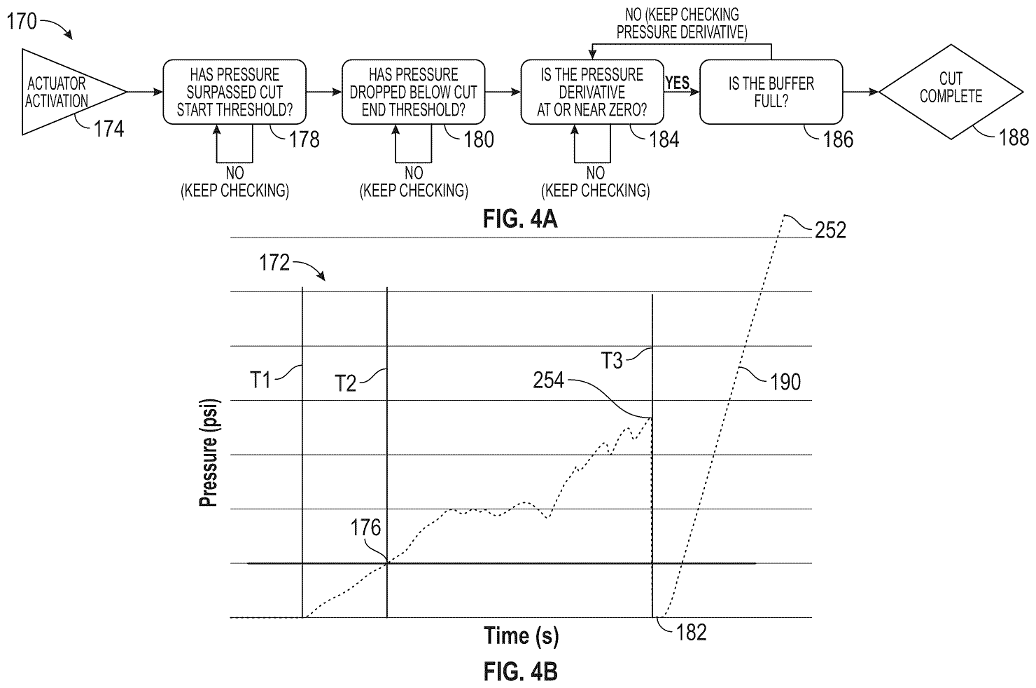

FIGS. 4A-7B illustrate flowcharts and graphical representations of example processes that use pressure sensor readings as feedback during a work operation. Generally, one or more stages of these processes is incorporated into low-level firmware algorithms embedded within the controller 144. The firmware can be a basic input/output system (BIOS), an extensible firmware interface (EFI), or another type of firmware. In some examples, a high-level firmware algorithm can be used. In particular, the high-level firmware algorithm is configured to be deployed within a flash memory chip and allows for updates to be made. In still further examples, the algorithm can be implemented within subsystems. These subsystems are configured to be semi-independent devices that are part of a more extensive system.

More specifically, FIG. 4A illustrates an example process 170 that uses measured pressure values and predetermined thresholds to initiate automatic blade retraction, with a corresponding graph 172 (see, e.g., FIG. 4B) illustrating pressure measurements over time during the execution of the process 170. As shown in FIG. 4A, at stage 174 the user activates the tool via actuation of the actuator (e.g., pressing the trigger 112). In some examples, activation of the actuator includes detection that the trigger 112 has been pulled which is sensed by the controller 144 and initiates startup of the motor 158 at stage 174 (e.g., see T1 on graph 172). After the motor 158 is started, the motor 158 drives the pump 152 to begin pressurizing the hydraulic circuit 150, causing hydraulic fluid to flow from the reservoir 148 through the circuit 150 to initiate movement of the first blade 128 towards the second blade 130.

During operation of the motor 158, the controller 144 continually monitors whether pressure in the hydraulic circuit 150 has exceeded a first threshold 176, which indicates that a cutting operation has started at stage 178 (e.g., see T2 on graph 172). In this way, the first threshold 176 serves as a “cut start threshold” that distinguishes between initial system pressurization and the higher pressures developed when the first blade 128 encounters resistance from a workpiece positioned in the cutting zone 126. In particular, the controller 144 receives pressure measurements from the pressure sensor 154 at regular intervals and compares these measurements against the first threshold 176, which are stored in memory 146 as a predetermined value based on the operational characteristics of the tool and workpiece properties. At stage 178, the controller 144 is configured to raise a flag in the firmware to indicate that the cut threshold 176 has been passed, providing a status indicator for subsequent process stages.

During the cutting operation, at stage 180, the controller 144 continually monitors the hydraulic circuit 150 pressure and checks whether the pressure has dropped below a second threshold 182 (e.g., see T3 on graph 172). In some examples, a pressure drop below the second threshold 182 indicates that the workpiece has been cut, as the resistance force applied by the workpiece is released when the workpiece is severed. In this way, the second threshold 182 functions as a “cut end threshold” and is set at a pressure value lower than the first threshold 176. As noted above with regard to the first threshold 176, the controller 144 receives ongoing pressure measurements from the pressure sensor 154 and compares these values against the second threshold 182 stored in memory 146. When the controller 144 determines that the cut end threshold 182 has been passed, the controller 144 can raise a flag in the firmware indicating the cut end threshold has been passed to indicate this status change

After the controller 144 determines that the workpiece has been cut, the process 170 advances to stage 184 where the controller 144 continually monitors a pressure derivative (e.g., configured as a ramp rate) to determine whether the derivative is at or near zero. The pressure derivative monitoring at stage 184 serves as an additional verification step to ensure that the cutting operation has been completed. For example, if the pressure derivative is not close to zero, this indicates that the hydraulic circuit 150 is still experiencing pressure changes and may be continuing to build pressure (e.g., is continuing to cut). In some examples, when the pressure derivative is near to zero, this indicates that there is no pressure building in the system, as the workpiece is no longer applying a counterforce to the blade(s).

In some examples, a buffer counter (e.g., a timer) may be implemented to verify that a cutting process is completed prior to initiating a dump sequence. This is particularly valuable for cutting operations involving workpieces such as stranded cable where the pressure derivative may drop to zero momentarily as the blades 128, 130 initially sever a strand of the cable, but then resume cutting once contacting another strand of the cable. This monitoring further prevents premature determination of cut completion in cases where partial cutting has occurred or where the workpiece material characteristics cause complex pressure response patterns during the severing process. The pressure derivative calculation may involve comparing successive pressure measurements over time to determine the rate of pressure change within the hydraulic circuit 150.

Once the pressure derivative is at or near zero (e.g., indicating that the workpiece has been cut), the firmware increments the buffer counter and the process 170 advances to stage 186. At stage 186, the controller 144 determines whether the buffer is full (e.g., a timer has expired), which corresponds to verifying that the pressure derivative has remained at or near zero for a preset amount of time. This time-based verification ensures that the pressure stabilization is sustained rather than temporary, further verifying that the cutting operation has been fully completed and that the hydraulic circuit 150 has reached a stable operating condition. In this example, the preset amount of time is configured to be in a range of about 50 milliseconds to about 250 milliseconds, although other time intervals may be selected based on tool characteristics, workpiece types, and operational requirements. When the pressure derivative moves outside the zero range (e.g., is greater than or less than zero), indicating that the tool 100 is building or dropping pressure, the firmware may decrement the buffer counter to account for pressure instability. In some implementations, the buffer may reset to zero when pressure variations are detected, or the firmware may decrement the buffer at a higher rate than it increments, such as decrementing by two milliseconds for each millisecond outside the zero pressure derivative range while only incrementing by one millisecond for each millisecond within the zero range. If the controller 144 determines that the pressure derivative has not remained at zero for the preset amount of time, the process 170 loops back to stage 184 where the controller 144 continually monitors the pressure derivative.

Once the pressure derivative or ramp rate has been at zero for the preset amount of time, the controller 144 determines that the cut has been completed at stage 188. The completion determination initiates the hydraulic dump sequence, which returns pressurized hydraulic fluid back to the reservoir 148, and retracts the first blade 128 back into a “home” position. Furthermore, at stage 188, the controller 144 clears the buffer counter and resets the status flags in the firmware. Accordingly, at stage 188, an operation reset is performed which indicates that the tool 100 is ready for another work operation.

The pressure release of the process 170 can permit the tool 100 to avoid deadhead or “bottoming out” after the workpiece has been cut, which may cause excessive pressure buildup and premature wear on system components. For example, execution of the process 170 and initiation of the dump sequence once the buffer verification is complete can mitigate pressure jumps in the hydraulic circuit 150, illustrated at section 190 in the graph 172. By mitigating the risk of these pressure spikes and associated mechanical stresses, the process 170 may further increase the useful life of the tool 100, while improving operational reliability and stability.

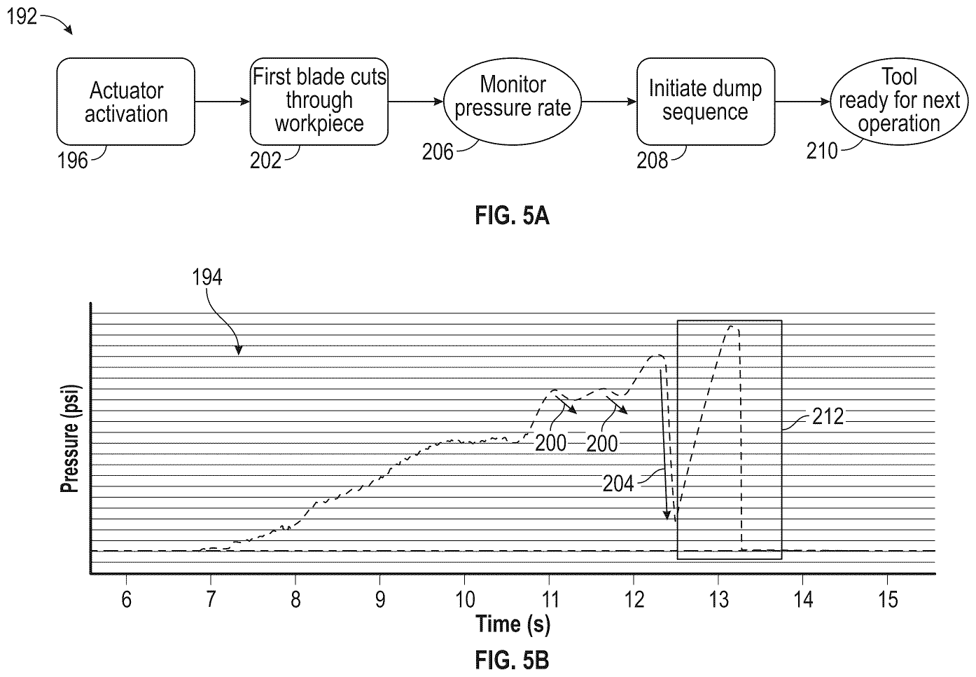

FIGS. 5A and 5B illustrate another example process 192 that uses pressure derivatives to initiate automatic blade retraction, with a corresponding graph 194 illustrating pressure measurements over time during the process 192. As shown in FIG. 5A, the process 192 begins at stage 196, which includes activation of an actuator. In this example, activation of the actuator includes the trigger 112 pull, which initiates the startup of the motor 158, and subsequent pressure rise in the hydraulic circuit 150. At stage 202, the first blade 128 cuts through the workpiece which causes a pressure drop in the hydraulic circuit 150 and indicated by arrows 200 in the graph 194 of FIG. 5B. At stage 206, the controller 144 continually monitors the pressure in the circuit 150 and determines when the pressure drops at a rate that exceeds a predetermined rate threshold 204 indicating the cutting operation is completed. Based on this determination, at stage 208, the motor 158 is stopped and the hydraulic dump sequence is initiated. In some examples, the the hydraulic dump sequence is initiated automatically without requiring the user to release the trigger 112. The process 192 then proceeds to stage 210 where an operation reset indicating the tool 100 is ready for another work operation is performed.

The pressure release of the process 192 can permit the tool 100 to avoid deadhead after the workpiece has been cut. For example, execution of the process 192 can prevent pressure jumps in the hydraulic circuit 150, illustrated at section 212 in the graph 194, after the workpiece has already been cut, which may extend the useful life of the tool 100 and improve operational reliability.

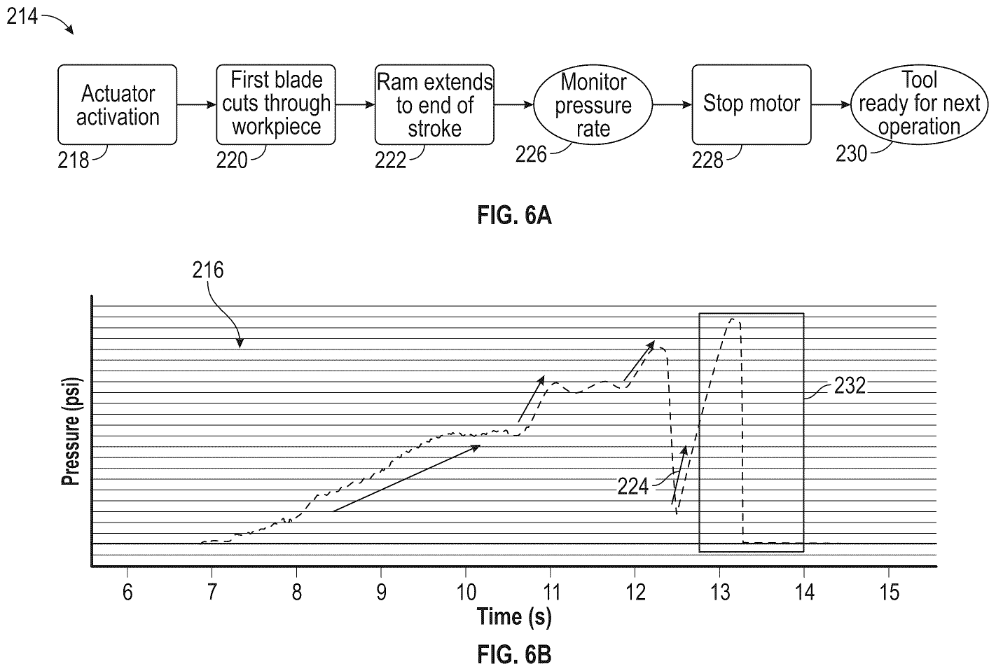

FIGS. 6A and 6B illustrates yet another example process 214 that uses pressure derivatives to initiate automatic blade retraction, with a corresponding graph 216 illustrating pressure measurements over time during the process 214. As shown in FIG. 6, the process 214 starts at stage 218 with activation of an actuator. In this example, activation of the actuator includes the trigger 112 pull which initiates the motor 158 startup and pressure rise in the hydraulic circuit 150. The process 214 proceeds to stage 220 where the first blade 128 cuts through the workpiece, which causes a pressure drop in the circuit 150. Once a piston or ram within the hydraulic circuit 150 reaches an end of its stroke, a pressure rises in the circuit 150 at stage 222. The process 214 then proceeds to stage 226 where the controller 144 monitors the pressure in the circuit 150 and detects when the pressure rises at a sharp enough rate that exceeds a predetermined rate threshold 224, which indicates that the tool 100 has reached a deadhead condition and initiates the dump sequence. This deadhead condition occurs when the hydraulic system encounters maximum resistance, which may result from completion of a cutting operation or from actuating the tool 100 without a workpiece positioned in the blades 128, 130. At stage 228, the motor 158 is stopped and trigger 112 is released. The process 214 then proceeds to stage 230 where an operation reset indicates that the tool 100 is ready for another work operation.

The pressure release of the process 214 allows the tool 100 to avoid deadhead after the workpiece has been cut. For example, execution of the process 214 prevents pressure jumps in the hydraulic circuit 150, illustrated at section 232 in the graph 216, after the workpiece has already been cut and the first blade 128 has reached the closed position and can no longer move distally. This, in turn, protects the system components of the tool 100 and extends tool 100 life.

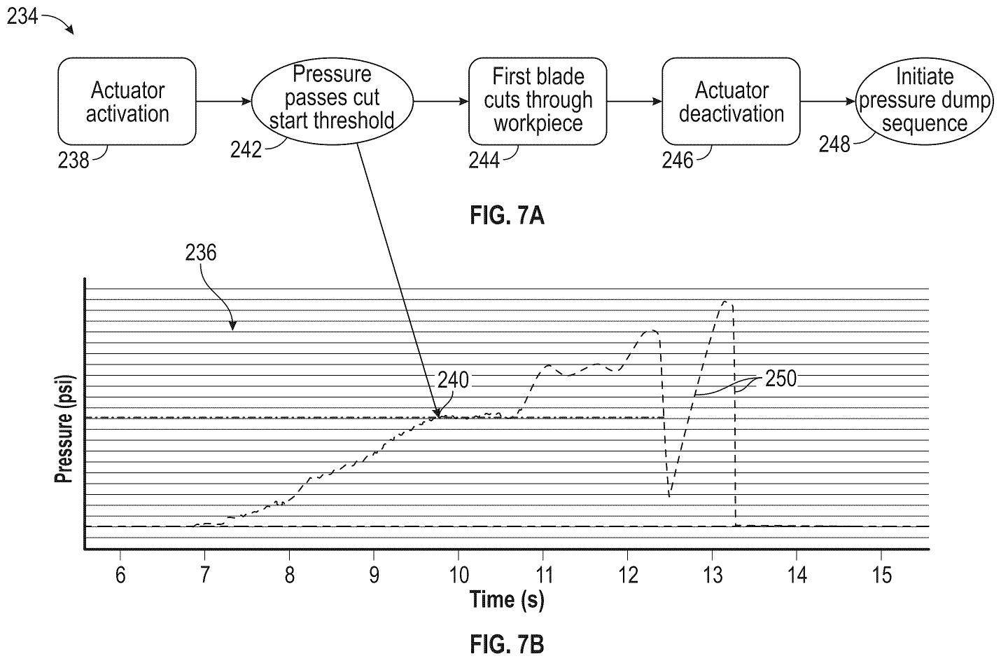

FIGS. 7A and 7B illustrate yet another example process 234 that uses pressure thresholds during a work operation, with a corresponding graph 236 illustrating pressure measurements over time during the process 234. As shown in FIG. 7A, the process 234 begins at stage 238 with activation of an actuator. In this example, the activation of the actuator includes the trigger 112 pull, which initiates the motor 158 startup, and begins a pressure rise in the circuit 150. At stage 242, the pressure in the hydraulic circuit 150 passes a first threshold 240 that indicates a cutting operation has started. At stage 244, the first blade 128 cuts through material of the workpiece that causes a pressure drop in the circuit 150. At stage 246, the actuator is deactivated. In this example, deactivation of the actuator includes the trigger 112 being released. After release of the trigger 112, the process 234 then proceeds to stage 248 where a hydraulic dump operation is initiated, as well as operation reset indicating the tool 100 is ready for another work operation.

According to the process 234 of FIG. 7A, if the user does not release the trigger 112 (e.g., stage 246 does not occur), the tool 100 may continue to run to deadhead conditions, as shown at section 250 by the large pressure changes at the end of the graph 236. This highlights the importance of user intervention in process 234, where manual trigger 112 release serves as the primary mechanism for initiating the dump sequence and prevents excessive pressure buildup and potential system damage after cutting completion.

FIGS. 4-7 each illustrate an implementation of algorithms with a linear sequence of events. The algorithm restarts after completion. However, in other implementations, one or more of these algorithms can be modified to include a while loop, for loop, or other firmware element, where the loops would allow the process to continue running until all conditions to stop are met. Additionally, in some implementations, different relevant measurements are taken in series. However, in further implementations, measurements can be taken at the same time or in a different order.

In light of the above, according to some examples, a hydraulic tool 100 utilizes pressure measurements and thresholds to initiate automatic blade retraction after the hydraulic tool 100 completes a cut or crimp, by automatically dumping fluid from its hydraulic circuit 150 back to its fluid reservoir 148, to mitigate force or pressure on the tool 100. Accordingly, one benefit of this feature is that it prevents the tool 100 from reaching a maximum force or quality pressure after each cut, thereby potentially helping improve reliability of the tool 100. In some examples, each of the thresholds described above may be a single threshold stored in memory 146. In other examples, each threshold may comprise a plurality of thresholds stored in a look-up table in memory 146, and the controller 144 can retrieve a respective threshold from the look-up table based on particular operating variables, such as cut/crimp type, workpiece material type, etc.

Additionally, in some examples, the hydraulic tool 100 monitoring pressure over the course of a work operation can provide additional benefits. For example, during the work operation, the controller 144 can store in memory 146 both a maximum cut/crimp pressure (e.g., a maximum pressure needed to cut/crimp the workpiece) and a maximum cycle pressure (e.g., a maximum pressure reached during the work operation).

For example, generally, when a user cuts a material and then continues to extend the ram in the hydraulic circuit 150 until deadhead, a tool 100 may log the maximum cycle or quality pressure sensed until the trigger 112 is released. This maximum pressure, however, may not be the pressure the tool 100 required to cut the material. By way of example, referring back to FIG. 4, a maximum cycle pressure 252 is shown in the graph 172. This maximum cycle pressure 252 is reached after the workpiece has already been cut. On the other hand, a maximum cut/crimp pressure 254 is also shown in FIG. 4, indicating a maximum pressure sensed during the work operation, which is less than the maximum cycle pressure 252.

As these are often two different pressures, with the maximum cycle pressure 252 generally larger than the maximum cut pressure 254, the controller 144 can store both pressures 252, 254 in memory 146. In some examples, these pressures 252, 254 can be stored in a look-up table in memory 146. Such data can be beneficial for both engineering and service. For example, the data can be used for determining what kind of cables are being cut to assist with optimizing threshold settings. As another example, that data can help set better day-in-the-life cycles for life testing of the tool 100.

Accordingly, during a work operation, when pressure measurements indicate a cut is completed, the controller 144 can store a maximum pressure of the cycle up to that point (e.g., from when the trigger 112 is depressed to when the respective threshold is met) as the maximum cut pressure 254 in memory 146. For example, this may occur at stage 184 of FIG. 4, at stage 206 of FIG. 5, and stage 226 of FIG. 6. When the overall cycle is completed, such as at stage 188 of FIG. 4, at step 210 of FIG. 5, at stage 230 of FIG. 6, or at stage 248 of FIG. 7, the controller 144 can store an overall maximum pressure of the cycle (e.g., from when the trigger 112 is depressed to when the trigger 112 is released) as the maximum cycle pressure 252 in memory 146.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

### Further Examples

Example 1. A hydraulic power tool, comprising: a trigger; a motor; a pump driven by the motor; a hydraulic circuit in fluid communication with the pump; a fluid reservoir in communication with the hydraulic circuit to store a hydraulic fluid; a pressure sensor in communication with the hydraulic circuit; and a controller in communication with the motor, the pressure sensor, and the trigger, the controller to: initiate motor operation in response to depression of the trigger, the motor operation to cause the pump to move hydraulic fluid from the fluid reservoir through the hydraulic circuit; monitor a pressure within the hydraulic circuit via pressure measurements from the pressure sensor; calculate a pressure derivative representing a rate of change of the pressure over time; increment a buffer counter when the pressure derivative is at or near zero; detect when the pressure derivative remains at or near zero for a predetermined time period to indicate that a work operation is complete; and when the pressure derivative is detected to be at or near zero for the predetermined time period, automatically release the hydraulic fluid from the hydraulic circuit back to the fluid reservoir.

Example 2. The hydraulic power tool of Example 1, wherein the controller further determines when the pressure drops below a threshold, wherein the threshold is a rate threshold indicative of the rate of change of the pressure measurements over time.

Example 3. The hydraulic power tool of Example 2, wherein the rate threshold is indicative of a completion of a cut by the hydraulic power tool.

Example 4. The hydraulic power tool of Example 2, wherein the rate threshold is indicative of a piston of the hydraulic circuit reaching a closed position.

Example 5. The hydraulic power tool of Example 1, wherein the controller is further configured to monitor the pressure derivative within the hydraulic circuit and determine when the pressure derivative is at or near zero for a predetermined time period before automatically releasing the hydraulic fluid.

Example 6. The hydraulic power tool of Example 5, wherein the predetermined time period is in a range of about 50 milliseconds to about 250 milliseconds.

Example 7. The hydraulic power tool of Example 1, wherein the controller is further configured to detect when the pressure within the hydraulic circuit exceeds a first threshold indicating initiation of the work operation and subsequently detect when the pressure drops below a second threshold indicating completion of the work operation.

Example 8. The hydraulic power tool of Example 7, wherein the second threshold has a pressure value that is lower than the first threshold.

Example 9. The hydraulic power tool of Example 7 or Example 8, further comprising at least one of: recording and storing a maximum pressure sensed during the work operation, the work operation defined from when the trigger is depressed to when the pressure exceeds the second threshold; or recording and storing a maximum pressure sensed during a work cycle, the work cycle defined from when the trigger is depressed to when the trigger is released.

Example 10. The hydraulic power tool of Example 1, wherein the controller includes a buffer counter that is incremented when a pressure derivative is at or near zero and decremented when the pressure derivative is not close to zero.

Example 11. The hydraulic power tool of Example 10, wherein the controller automatically releases the hydraulic fluid when the buffer counter reaches a predetermined full state.

Example 12. A method of operating a hydraulic power tool, the method comprising: initiating motor operation in the hydraulic power tool in response to activation of an actuator of the hydraulic power tool; activating a pump of the hydraulic power tool, via initiation of the motor operation, to move hydraulic fluid from a fluid reservoir through a hydraulic circuit; monitoring a pressure within the hydraulic circuit via a pressure sensor arranged within the hydraulic power tool; calculating a pressure derivative representing a rate of change of the pressure over time; incrementing a buffer counter when the pressure derivative is at or near zero; detecting when the pressure derivative remains at or near zero for a predetermined time period indicating a work operation of the hydraulic tool is completed; and upon detecting that the pressure derivative remains at or near zero for a predetermined time period, releasing the hydraulic fluid from the hydraulic circuit back to the fluid reservoir.

Example 13. The method of Example 12, wherein the predetermined time period is in a range of about 50 milliseconds to about 250 milliseconds.

Example 14. The method of Example 12 or Example 13, further comprising detecting when the pressure within the hydraulic circuit exceeds a first threshold indicating initiation of the work operation before monitoring the pressure derivative.

Example 15. The method of Example 14, further comprising detecting when the pressure within the hydraulic circuit drops below a second threshold indicating preliminary completion of the work operation before calculating the pressure derivative.

Example 16. The method of any one of Examples 12 to 15, further comprising raising status flags in firmware when predetermined pressure conditions are detected during the work operation.

Example 17. A method of operating a hydraulic power tool, the method comprising: initiating motor operation in a hydraulic power tool in response to activation of an actuator; pumping hydraulic fluid from a fluid reservoir through a hydraulic circuit via initiation of the motor operation; monitoring a pressure within the hydraulic circuit; detecting when the pressure varies at a rate that exceeds a first threshold indicating a work operation of the hydraulic tool is completed; and upon detecting that the pressure varies at the rate that exceeds the first threshold indicating the work operation is completed, releasing the hydraulic fluid from the hydraulic circuit back to the fluid reservoir.

Example 18. The method of Example 17, wherein the first threshold corresponds to a pressure drop rate.

Example 19. The method of Example 17, wherein the first threshold corresponds to a pressure rise rate.

Example 20. The method of any one of Examples 17 to 19, further comprising raising status flags in firmware upon detecting that the pressure varies at the rate that exceeds the first threshold.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C”indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive.

Also as used herein, unless otherwise limited or defined, “substantially perpendicular” indicates a direction that is within ±12 degrees of perpendicular a reference direction (e.g., within ±6 degrees), inclusive.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±10%, inclusive. Where specified, “substantially” can indicate in particular a variation in one numerical direction relative to a reference value. For example, “substantially less” than a reference value (and the like) indicates a value that is reduced from the reference value by 10% or more, and “substantially more” than a reference value (and the like) indicates a value that is increased from the reference value by 10% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A hydraulic power tool, comprising:
a trigger;
a motor;
a pump driven by the motor;
a hydraulic circuit in fluid communication with the pump;
a fluid reservoir in communication with the hydraulic circuit to store a hydraulic fluid;
a pressure sensor in communication with the hydraulic circuit; and
a controller in communication with the motor, the pressure sensor, and the trigger, the controller to:
initiate motor operation in response to depression of the trigger, the motor operation to cause the pump to move hydraulic fluid from the fluid reservoir through the hydraulic circuit;
monitor a pressure within the hydraulic circuit via pressure measurements from the pressure sensor;
calculate a pressure derivative representing a rate of change of the pressure over time;
increment a buffer counter when the pressure derivative is at or near zero;
detect when the pressure derivative remains at or near zero for a predetermined time period to indicate that a work operation is complete; and
when the pressure derivative is detected to be at or near zero for the predetermined time period, automatically release the hydraulic fluid from the hydraulic circuit back to the fluid reservoir.

2. The hydraulic power tool of claim 1, wherein the controller further determines when the pressure drops below a threshold, wherein the threshold is a rate threshold indicative of the rate of change of the pressure measurements over time.

3. The hydraulic power tool of claim 2, wherein the rate threshold is indicative of a completion of a cut by the hydraulic power tool.

4. The hydraulic power tool of claim 2, wherein the rate threshold is indicative of a piston of the hydraulic circuit reaching a closed position.

5. The hydraulic power tool of claim 1, wherein the controller is further configured to monitor the pressure derivative within the hydraulic circuit and determine when the pressure derivative is at or near zero for a predetermined time period before automatically releasing the hydraulic fluid.

6. The hydraulic power tool of claim 5, wherein the predetermined time period is in a range of about 50 milliseconds to about 250 milliseconds.

7. The hydraulic power tool of claim 1, wherein the controller is further configured to detect when the pressure within the hydraulic circuit exceeds a first threshold indicating initiation of the work operation and subsequently detect when the pressure drops below a second threshold indicating completion of the work operation.

8. The hydraulic power tool of claim 7, wherein the second threshold has a pressure value that is lower than the first threshold.

9. The hydraulic power tool of claim 7, further comprising at least one of:
recording and storing a maximum pressure sensed during the work operation, the work operation defined from when the trigger is depressed to when the pressure exceeds the second threshold; or
recording and storing a maximum pressure sensed during a work cycle, the work cycle defined from when the trigger is depressed to when the trigger is released.

10. The hydraulic power tool of claim 1, wherein the controller includes a buffer counter that is incremented when a pressure derivative is at or near zero and decremented when the pressure derivative is not close to zero.

11. The hydraulic power tool of claim 10, wherein the controller automatically releases the hydraulic fluid when the buffer counter reaches a predetermined full state.

12. A method of operating a hydraulic power tool, the method comprising:
initiating motor operation in the hydraulic power tool in response to activation of an actuator of the hydraulic power tool;
activating a pump of the hydraulic power tool, via initiation of the motor operation, to move hydraulic fluid from a fluid reservoir through a hydraulic circuit;
monitoring a pressure within the hydraulic circuit via a pressure sensor arranged within the hydraulic power tool;
calculating a pressure derivative representing a rate of change of the pressure over time;
incrementing a buffer counter when the pressure derivative is at or near zero;
detecting when the pressure derivative remains at or near zero for a predetermined time period indicating a work operation of the hydraulic tool is completed; and
upon detecting that the pressure derivative remains at or near zero for a predetermined time period, releasing the hydraulic fluid from the hydraulic circuit back to the fluid reservoir.

13. The method of claim 12, wherein the predetermined time period is in a range of about 50 milliseconds to about 250 milliseconds.

14. The method of claim 12, further comprising detecting when the pressure within the hydraulic circuit exceeds a first threshold indicating initiation of the work operation before monitoring the pressure derivative.

15. The method of claim 14, further comprising detecting when the pressure within the hydraulic circuit drops below a second threshold indicating preliminary completion of the work operation before calculating the pressure derivative.

16. The method of claim 12, further comprising raising status flags in firmware when predetermined pressure conditions are detected during the work operation.

17. A method of operating a hydraulic power tool, the method comprising:
initiating motor operation in a hydraulic power tool in response to activation of an actuator;
pumping hydraulic fluid from a fluid reservoir through a hydraulic circuit via initiation of the motor operation;
monitoring a pressure within the hydraulic circuit;
detecting when the pressure varies at a rate that exceeds a first threshold indicating a work operation of the hydraulic tool is completed; and
upon detecting that the pressure varies at the rate that exceeds the first threshold indicating the work operation is completed, releasing the hydraulic fluid from the hydraulic circuit back to the fluid reservoir.

18. The method of claim 17, wherein the first threshold corresponds to a pressure drop rate.

19. The method of claim 17, wherein the first threshold corresponds to a pressure rise rate.

20. The method of claim 17, further comprising raising status flags in firmware upon detecting that the pressure varies at the rate that exceeds the first threshold.
